(19) United States
(12) Patent Application Publication
(10) Pub. No.: US 2018/0271005 A1
(43) Pub. Date: Sep. 27, 2018

(54) SOWER

(71) Applicant: MATERMACC S.P.A., San Vito al Tagliamento (PN) (IT)

(72) Inventors: Andrea BEDOSTI, BOLOGNA (IT); Massimo ZUBELLI, Gualtieri (RE) (IT); Michele TRIVILLIN, San Vito al Tagliamento (PN) (IT); Andrea DRECOGNA, Premariacco (UD) (IT)

(73) Assignee: MATERMACC S.P.A., San Vito al Tagliamento (PN) (IT)

(21) Appl. No.: 15/758,673

(22) PCT Filed: Oct. 12, 2016
(86) PCT No.: PCT/IB2016/056088

§ 371 Date: Mar. 8, 2018

(30) Foreign Application Priority Data
Oct. 20, 2015 (IT) 102015000063511

(51) Int. Cl. A01C 5/06; A01B 15/16

(52) U.S. Cl. CPC A01C 5/064; A01C 7/046; A01B 15/16

(57) ABSTRACT

A group for cleaning and making a furrow in a ground, comprising: —a frame suitable to be connected to a driving unit; —a rotary grooving disc provided with grooves; wherein the grooving disc is articulated to the frame in a mobile fashion perpendicularly to the ground with respect to the frame by means of a resilient articulated group provided with mutually parallel articulation axes, and wherein the resilient articulated group comprises at least one plurality of arms articulated with respect to mutually parallel articulation axes, among which there is at least one resiliently flexibly yieldable arm.

### TECHNICAL FIELD

The present invention regards a group for cleaning and making a furrow in the ground, more in particular a group for cleaning and making a furrow in the ground suitable to be transported by a driving unit, such as a farming tractor.

### PRIOR ART

Sowers, especially sowers required to be transported by a farming driving unit, have a sowing group generally articulated to a frame in turn fixed to the driving unit so as to be made to advance, along an advancement direction, on the ground so as to release a measured amount of seeds in a special furrow made in the ground.

In order to make the furrow, the frame generally comprises a shaped rotary disc, referred to as turbo disc, which, arranged rearwardly to the sowing group with respect to the advancement direction imparted by the driving unit and integrally fixed to the frame with rotational axis orthogonal to the advancement direction and parallel to the ground, cuts the ground at a desired depth.

The turbo disc may be preceded by rotary row cleaner discs, i.e. idle discs having an inclined rotational axis with respect to the rotational axis of the shaped rotary disc and designated to push any residual material of the previous cultivations present on the ground to be sown sideways.

Also the row cleaners are supported by a frame in a fixed position with respect thereto, for example by means of brackets rigidly fixed thereto.

Given that the turbo discs and row cleaner discs are arranged at a fixed height with respect to the ground during use, they do not detect any height variations of the ground, especially if marked, and thus they have an operating height that may not be sufficiently deep in the presence of ground subsidence and, vice versa, it could be excessively deep in the presence of ridges.

A further example of a group for cleaning and making a furrow in the ground is shown in the patent application nr. US 2011/120357.

An object of the present invention is to overcome the aforementioned drawbacks of the prior art through a solution that is simple, rational and inexpensive while simultaneously maintaining such discs of the sowing group light and free.

These objects are attained by the characteristics of the invention, which are outlined in the independent claim. The dependent claims outline preferred and/or particularly advantageous aspects of the invention.

### DESCRIPTION OF THE INVENTION

In particular, the invention provides a group for cleaning and making a furrow in a ground, comprising:
a frame suitable to be connected to a driving unit;
a rotary grooving disc provided with grooves;
wherein the grooving disc is articulated to the frame in a mobile fashion perpendicularly to the ground with respect to the frame by means of a resilient articulated group provided with mutually parallel articulation axes.

According to the invention, the resilient articulated group comprises at least one plurality of arms articulated with respect to mutually parallel articulation axes, among which there is at least one resiliently flexibly yieldable arm.

This solution enables obtaining constant pressure on the ground as well as high operating excursion (cutting depth and/or height variation of the cutting depth) suitable to overcome problems related to operating conditions on highly uneven grounds.

Moreover, this solution enables providing a self-levelling resilient articulated group that is easy and functional.

Preferably, the resilient articulated group may comprise a first arm connected to the grooving disc, a second arm fixed to the frame, a third arm hinged to the first arm and to the second arm and a fourth arm that is resiliently yieldable rigidly connected to the first arm and the second arm.

A further aspect of the invention may provide for that the grooving disc be pivotingly associated to the resilient articulated group about an oscillation axis perpendicular to the articulation axes of the resilient articulated group.

This solution enables, especially during curves imparted by the advancement direction of the group, reducing the stresses (flexural/torsional stress) on the grooving disc which is thus less subjected to breakage.

Advantageously, the group may comprise at least one element for limiting the rotation of the grooving disc about the oscillation axis.

Thus, the oscillations may be reduced and the furrow made in the ground by the grooving disc may remain well defined.

Advantageously, the group may also comprise at least one element (which could be defined by the aforementioned element) for limiting the movement of the grooving disc about the articulation axis of the resilient articulated group.

This solution enables providing an end stop element, for example lower, for varying the height of the grooving disc.

In addition, the group may comprise at least one rotary row cleaner disc arranged sideways to the grooving disc and having a revolution axis that is inclined with respect to the rotation axis of the grooving disc, the row cleaner disc being articulated to the frame of said resilient articulated group.

This solution enables the removal of the residual material—from the previous cultivations present in the ground—from the furrow and discarding them therebeside.

Thanks to this solution, the residual material—from the previous cultivations present in the ground—may be removed from the furrow and discarded therebeside.

The invention also provides a sower comprising a group for cleaning and making a furrow in the ground as described above and a sowing group associated to the frame of the group for cleaning and making a furrow in the ground rearwardly (and aligned) thereto with respect to an advancement direction on the ground.

Upon making and cleaning the furrow, the sower sows the seed in the furrow (possibly refined).

Advantageously, the sowing group is articulated to the frame by means of a four-bar hinge having articulation axes parallel to the articulation axes of the resilient articulated group.

In addition, the limiting element of the group for cleaning and making a furrow in the ground comprises a non-extensible flexible member fixed to the sowing group and connected to the grooving disc.

This solution enables providing an end stop element, for example lower, for varying the height of the grooving disc and this element additionally allows copying the oscillation of the sowing group without burdening the structure of such sowing group.

An aspect of the invention that can be protected independently with respect to the description above could provide a group for cleaning and making a furrow in a ground comprising:
a frame suitable to be connected to a driving unit;
a rotary grooving disc provided with grooves;
   wherein the grooving disc is pivotingly associated to the frame about an oscillation axis substantially perpendicular to the ground.

This solution enables, especially during curves imparted by the advancement direction of the group, reducing the stresses (flexural/torsional stress) on the grooving disc which is thus less subjected to breakage.

### BRIEF DESCRIPTION OF THE DRAWINGS

Further characteristics and advantages of the invention will be apparent from reading the flowing description—provided by way of non-limiting example—with reference to the figures illustrated in the attached drawings.

FIG. 1 is a lateral view of a sower according to the invention.

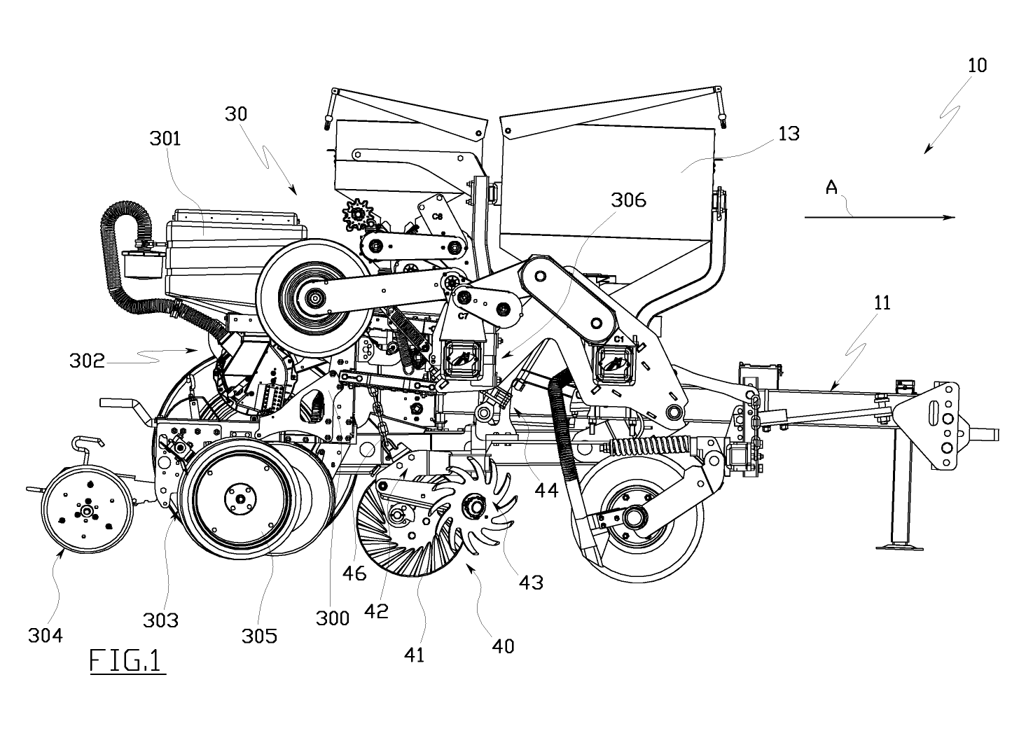

FIG. 2 is an axonometric view of a group for cleaning and making a furrow in a ground.

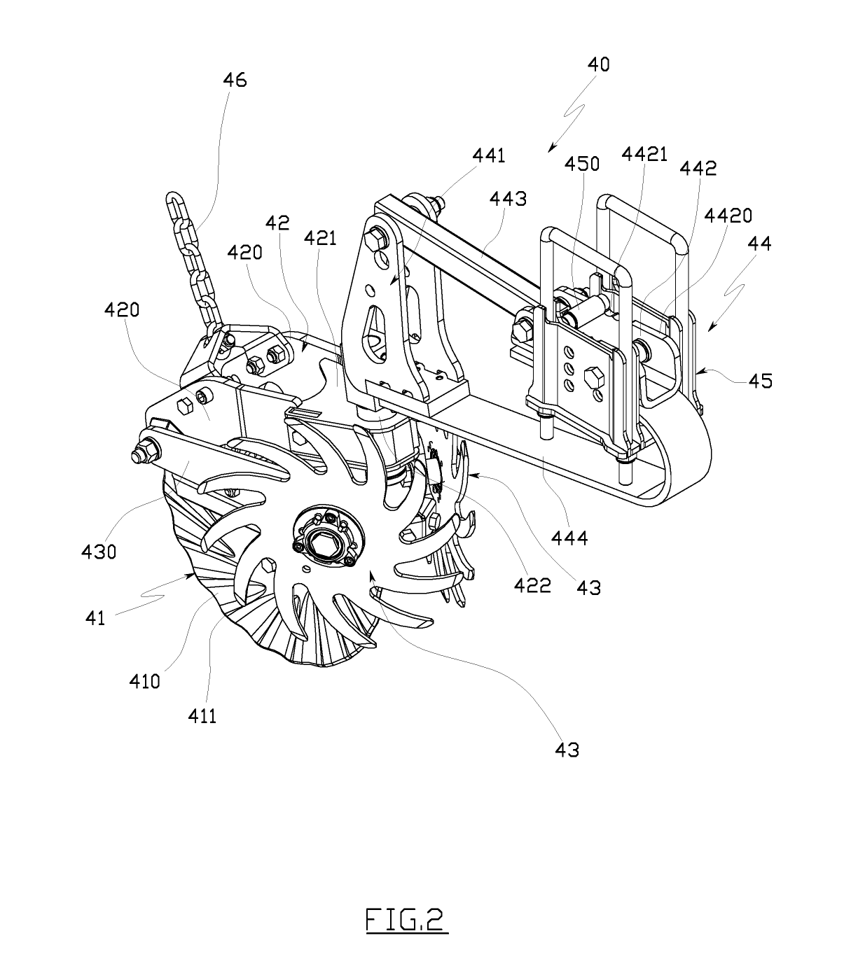

FIG. 3 is a lateral view of FIG. 2.

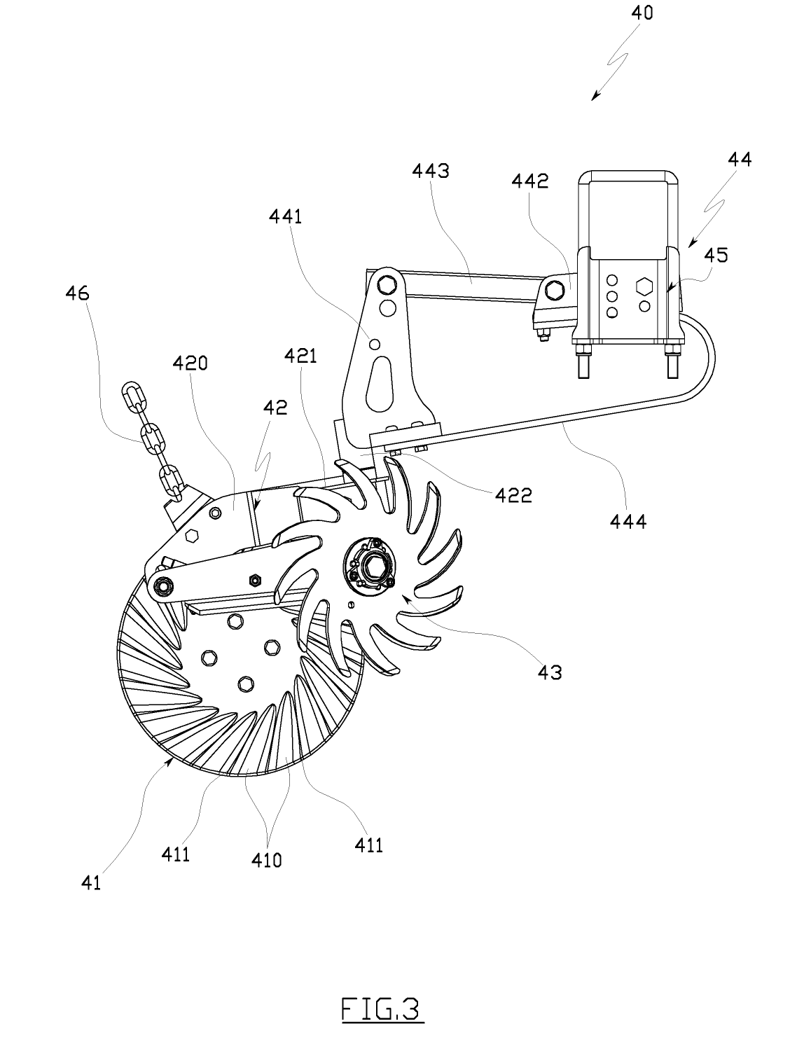

FIG. 4 is an anterior-frontal view of FIG. 2.

### BEST EMBODIMENT OF THE INVENTION

With particular reference to such figures, a sower—for example a pneumatic precision sower—is indicated in its entirety with 10.

The sower 10 comprises a frame 11, for example comprising a metal longitudinal beam, rigid and arranged horizontally (with reference to the figures), to which there are connected a pair of wheels (not shown) which enable supporting and moving the sower 10.

The frame 11 is suitable to be associated, as known to a man skilled in the art, rearwardly to an agricultural machine, for example a tractor, so as to be moved forward along an advancement direction A for sowing the ground.

The frame 11 is for example made up of at least one longitudinal beam, in the example two longitudinal beams parallel to each other and perpendicular to the advancement direction A (one front and one rear with respect to the advancement direction A) integrally joined to each other by means of a central crosspiece parallel to the advancement direction A.

To the frame 11, for example at the upper part thereof, there may be fixed a fertiliser spreader tank 13 provided with lower nozzles from which a fertiliser spreader group, for example of the pneumatic type, draws a measured amount of fertiliser to be spread on the ground during the advancement of the sower 10 along the advancement direction A.

In addition, to the lateral ends of the frame 11 there may be hinged two row markers (not shown), for example of the hydraulic type, mobile between a lowered position and a raised position, as known to a man skilled in the art.

The sower 10 comprises a plurality of sowing groups 30, for example identical to each other which are fixed to the rear longitudinal beam of the frame 11.

Each sowing group 30 comprises a substantially rigid framework 300, for example metallic, which is suitable to support a respective tank 301, which contains a plurality of seeds to be dispensed on the ground.

The tank 301 is for example closed, for example by an upper substantially sealed cover, and it has a lower outlet mouth, for example tubular.

On the framework 300 there is mounted a dispensing group 302, which is connected to the tank 301 (to the outlet mouth thereof) and it is suitable to dispense a measured amount of seeds, for example one seed at a time. The dispensing group 302, for example, is a pneumatic precision sower, which is preferably obtained as described in document EP 0536543, fully referred to herein.

Such precision sowing device (whose interior details are not shown herein) comprises a perforated disc, having a plurality of circular holes, which rotates and cooperates—on the one hand—with an air aspiration device (not shown), which creates a depression through the holes of the disc keeping the seeds stuck to the disc up to a release area, and—on the other hand—with a mechanical selector which facilitates the selection of a single seed.

In addition, the dispensing group 302 is such to define the distance between the seeds dispensed along the advancement direction as a function of the advancement speed of the sower 10. The rotary disc could take motion from the wheels of the sower 10, as known to a man skilled in the art, or from other motion transformation means.

In addition, the framework 300 supports a grooving element 303, for example of the disc or double disc or “harrow” type, which is fixed to the framework 300. For example, the grooving element 303 is arranged beneath the framework 300, so as to come into contact with the ground and it is arranged upstream of the point where the seed dispensed by the dispensing group 302 drops in the advancement direction of the sower 10 along the advancement direction A.

In addition, the framework 300 supports a group 304 for closing the furrow made on the ground by the grooving element 303, which is for example fixed in an adjustable fashion, height-wise for example, to the framework 300 and it is arranged downstream of the point where the seed drops in the advancement direction of the sower 10 along the advancement direction A.

The closing group 304 for example comprises a plurality of rotary discs inclined with respect to each other and with rotational axis inclined with respect to the horizontal.

In addition, the framework 300 rotatably supports at least one depth wheel 305, which is arranged upstream of the closing group 304 along an axis parallel to the advancement direction A.

In the example, each sowing group 30 has two tanks 301, two dispensing groups 302, two grooving elements 303, two closing groups 304 and two (pairs of) depth wheels 305 arranged adjacent to each other in the direction perpendicular to the advancement direction A, i.e. along the longitudinal axis of the rear longitudinal beam to which they are fixed.

Each framework 300 of each sowing group 30 comprises in the front area thereof, with respect to the advancement direction A, at least one engagement portion 306 configured to define a stable coupling to the rear longitudinal beam.

In the example, each sowing group 30 has at least one pair (four in the example) of engagement portions 306 arranged adjacent (and spaced) along the direction perpendicular to the advancement direction A, i.e. along the axis of the rear longitudinal beam to which they are fixed.

Each engagement portion 306 comprises a coupling flange, which is for example fixed (for example in an integrally joined or oscillating fashion by means of damping means) to the framework 300, for example by means of two rigid brackets (suitably locked and/or damped).

For example, the coupling flange defines a flat surface (substantially vertical) suitable to abut against a rear surface of the rear longitudinal beam, substantially perfectly fitting therewith.

The coupling flange has a height greater than the vertical thickness of the rear longitudinal beam, so as to be able to define two projecting portions, above and beneath it, when the flat surface is at contact with the rear surface of the rear longitudinal beam.

The engagement portion 306 also comprises a substantially C-shaped rigid tensioning rod, with concavity facing rearwardly with respect to the advancement direction A, which is adjustably fixed to the coupling flange, for example at the through holes (vertically aligned) and made on the projecting portions thereof, so that the rigid tensioning rod, once connected with the coupling flange, may define a closed loop profile therewith.

The C shape of the rigid tensioning rod is substantially complementary to the outer section of the rear longitudinal beam, so as to come to contact with the lower, upper and front surface thereof.

Basically, the rigid tensioning rod is provided with threaded fixing members, for example at the free ends thereof, so as to be able to adjust the width of the ring (substantially quadrangular shaped) defined between the coupling flange and the rigid tensioning rod.

The engagement portion 306 of each sowing group 30 is basically such to be able to define a prismatic connection with the rear longitudinal beam and it is such to be able to be locked in an axial position of the rear longitudinal beam by fastening the fixing members.

The coupling flange is then articulated to the framework 300 by means of two connecting rods (parallel) which define—with the coupling flange and the framework 300—a four-bar hinge, preferably an articulated parallelogram, with articulation axes perpendicular to the advancement direction and substantially horizontal (parallel to the rear longitudinal beam), which articulates the sowing group 30 to the framework 11, i.e. to the rear longitudinal beam of the frame.

The sower 10 further comprises a group 40 for cleaning and making a furrow in a ground, which is associated to the frame 11 frontwardly to the sowing group 30 with respect to the advancement direction A, the sower for example comprising a plurality of groups 40, for example one for each sowing group 30.

The group 40 is for example associated, as better described hereinafter, to the front longitudinal beam of the frame 11.

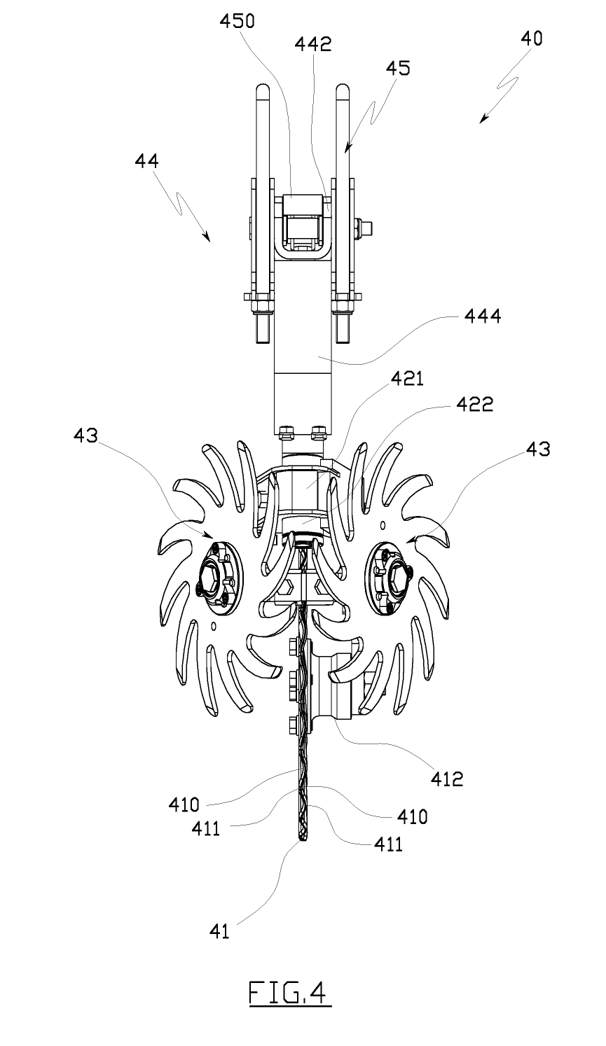

The group 40 comprises a grooving disc 41 rotating and shaped so as to have a sharp profile and sides provided with grooves 410 and reliefs 411 (see FIG. 4).

For example, the grooving disc is aligned along the advancement direction A with respect to each grooving element 303.

Basically, the two adjacent grooves 410 are divided by a relief 411.

For example, the grooves 410 (and the reliefs 411) are arranged with the longitudinal axis inclined with respect to the radial direction of the grooving disc 41 for example rearwardly by an acute angle)(30°-60° with respect to the radial direction, so as to be able to enter into the ground substantially vertical and project the cut ground (and/or any roots and the like) rearwardly.

For example, the juxtaposed sides of the grooving disc are substantially complementary and to a relief of one side there corresponds a groove in the juxtaposed side while to a groove in one side there corresponds a relief in the juxtaposed side

To one side of the grooving disc 41 there is coaxially fixed a shaft 412, which is rotatably supported by a rigid structure 42.

The structure 42 is defined by a fork body having a pair of prongs 420 at least provided alongside parts juxtaposed to a portion of the grooving disc 41.

Each prong 420 of the fork body defining the structure 42 has a free rear end (with respect to the advancement direction A) and a front end joined to the front end of the other prong 420 by means of a joining body 421.

The group 40 further comprises a rotary row cleaner disc 43, for example due to the force exerted by the ground when the sower 10 is made to advance along the advancement direction A.

The row cleaner disc 43 is arranged sideways to the grooving disc 41 with an inclined revolution axis with respect to the rotation axis of the grooving disc 41 defined by the shaft 412.

The inclination of the row cleaner disc 43 is such that the front end (with respect to the advancement direction A) of the row cleaner disc 43 is closer to the grooving disc 41 as compared to the rear end of the row cleaner disc 43.

In this manner, the residual material present on the ground is discarded sideways to the furrow made by the grooving disc 41 due to the rotation of the row cleaner disc 43.

The row cleaner disc 43 comprises a plurality of substantially radial sheets or (as illustrated) having a backwards curved profile with respect to the rotational direction imparted by the ground.

Basically, the row cleaner disc 43 is fitted on a rotary shaft coaxially associated and projecting from the face of the row cleaner disc 43 proximal to the grooving disc 41.

The rotary shaft is supported in rotation (idle) by a support bar 430, for example rigid, which is constrained to the structure 42.

For example, the support bar 430 comprises a front end (with respect to the advancement direction A) connected to the row cleaner disc 43, i.e. provided with a rotational support for the rotary shaft of the row cleaner disc 43, and a rear end (with respect to the advancement direction A) associated to the rear end of a prong 420 of the structure 42.

Basically, the row cleaner disc 43 is associated sideways and frontwardly (slightly) with respect to the grooving disc 41 with respect to the advancement direction A.

The group 40 comprises a pair of row cleaner discs 43 associated, as mentioned above, on opposite sides with respect to the grooving disc 41.

The group 40 comprises a resilient articulated group 44 which articulates the grooving disc 41 and/or the row cleaner disc 43 to the frame 11, i.e. to the front longitudinal beam of the frame 11.

Basically, in the example, the resilient articulated group 44 articulates (directly) the structure 42 (which supports the grooving disc 41 and, for example, the row cleaner disc 43) to the frame 11, i.e. to the front longitudinal beam thereof.

The resilient articulated group 44 comprises articulation axes parallel to each other and perpendicular to the advancement direction A (i.e. substantially horizontal or parallel to the front longitudinal beam).

The resilient articulated group 44 comprises a first rigid arm 441 connected to the grooving disc 41, i.e. connected to the structure 42.

The first arm 441, for example comprises a fork body provided with a joining plate and two sides rising from the joining plate.

The joining plate is constrained to the structure 42, for example with a degree of freedom.

Basically, the structure 42 is pivotingly associated to the first arm 441, i.e. to the joining plate thereof, with respect to an oscillation axis perpendicular to the articulation axes of the resilient articulated group (and to the rotational axis of the grooving disc 41).

Basically, the joining body 421 of the structure 42 defines a cylindrical seat (through) in which there is received an oscillation pin 422 inserted into a cylindrical seat made in the joining plate of the first arm 441.

The oscillation pin 422 defines a hinge pin of the structure 42 with respect to the first arm 441.

In addition, the resilient articulated group 44 comprises a second arm 442 (juxtaposed to the first rigid arm 441) fixed to the frame 11, i.e. to the (beneath the) front longitudinal beam.

The second arm 442 comprises a surface 4420 (upper) suitable to rest against—at the lower part—a lower surface of the front longitudinal beam, substantially perfectly fitting therewith at least in one portion.

The surface 4420 (upper) is for example substantially planar.

The surface 4420 comprises a plurality of seats 4421, for example cylindrical, spaced along the longitudinal axis of the coupling flange (i.e. along the advancement direction A).

The second arm 442 is constrained to the front longitudinal beam of the frame 11 by means of a clamp element 45.

The clamp element 45 comprises a coupling flange arranged beneath the front longitudinal beam and substantially shaped cradle-like (with concavity facing towards the front longitudinal beam); the front and rear ends of the coupling flange are open so as to enable the passage of the ends of the second arm 442 which is received in the coupling flange with clearance.

The coupling flange has a width (along the advancement direction A) greater than the thickness of the front longitudinal beam in such direction, so as to define two projecting portions, at the front and rear part thereof, when the coupling flange is arranged beneath the front longitudinal beam.

The second arm 442 comprises an end (front) hinged, by means of a hinge pin, to the coupling flange of the clamp element, for example in proximity of the front open end thereof.

Basically, the hinge pin is vertically misaligned with respect to the seats 4421 of the second arm 442, i.e. it is arranged frontwardly thereto with respect to the advancement direction A.

The clamp element 45 also comprises a substantially C-shaped rigid tensioning rod, with concavity facing downwards, which is adjustably fixed to the coupling flange, for example at the through holes (vertically aligned) and made on the projecting portions thereof, so that the rigid tensioning rod, once connected with the coupling flange, may define a closed loop profile therewith.

The C shape of the rigid tensioning rod is substantially complementary to the outer section of the rear longitudinal beam, so as to come to contact with the upper, rear and front surface thereof.

Basically, the rigid tension rod is provided with threaded fixing members, for example at the free ends thereof, so as to be able to adjust the width of the ring (substantially quadrangular shaped) defined between the coupling flange and the rigid tensioning rod.

In the example, the clamp element 45 comprises a pair of rigid parallel tensioning rods.

Basically, the clamp element 45 is such to define a prismatic connection with the front longitudinal beam and it is such to be able to be locked in an axial position of the front longitudinal beam by fastening the fixing members.

The second arm 442 is constrained to the front longitudinal beam by means of the clamp element 45, which is configured to as to clamp-tighten the second arm 442 between the lower surface of the front longitudinal beam of the frame 11 and the upper surface of the coupling flange.

The second arm 442 is constrained to the front longitudinal beam with an adjustable inclination, by interposing a peg 450, for example cylindrical, which is housed in one of the seats 4421 and it is thus interposed between the lower surface of the front longitudinal beam of the frame 11 and the surface 4420 of the second arm 442.

The variation of the position of the peg 450 with respect to the advancement direction A causes a variation of the inclination of the second arm 442 with respect to the lower surface of the front longitudinal beam of the frame 11.

Basically, the positioning of the peg 450 in a front seat (proximal to the hinge pin that hinges the second arm 442 to the coupling flange of the clamp element 45) defines an inclination of the second arm 442 with respect to the lower surface of the front longitudinal beam of the frame 11 by a greater angle with respect to the inclination defined by the positioning of the peg 450 in a rear seat (distal from the hinge pin that hinges the second arm 442 to the coupling flange of the clamp element 45).

In addition, the resilient articulated group 44 comprises a third arm 443, for example rigid, whose ends (front and rear) are respectively hinged to the first arm 441 and to the second arm 442.

In particular, the rear end of the third arm 443 is hinged (by means of a hinge pin) to the upper end of the sides of the fork body of the first arm and the rear end of the third arm 443 is hinged (by means of a hinge pin) to the rear end of the second arm 442 projecting at the rear part from the coupling flange of the clamp element 45.

In addition, the resilient articulated group 44 comprises a fourth arm 444 (juxtaposed to the third arm 443) resiliently yieldable and rigidly connected to the first arm 441 and to the second arm 442

Basically, the rear end of the fourth arm 444 is rigidly fixed (by means of threaded members) to the lower end of the fork body of the first arm 441, for example of the joining plate, and the rear end of the fourth arm 444 is hinged (by means of threaded members) to the front end of the second arm 442.

The fourth arm 444 comprises a bar flexible (bending bar or leaf spring) in an elastic fashion (resilient).

Basically, the elasticity of the fourth arm 444 is such to define an imaginary hinge which constrains the fourth arm 444 with the second arm 442 and/or the first arm 441.

In the example, the fourth arm 444 is substantially curve-shaped, for example shaped to form a substantially capsized “C” profile, with concavity facing backwards.

Basically, the resilient articulated group 44 as described above defines an elastically yieldable (in the vertical direction) four-bar hinge which enables varying the height of the structure 42 and, thus, of the grooving disc 41 (and/or of the row cleaner disc 43) opposing the elastic thrust exerted by the fourth arm 444.

The resilient articulated group 44 as described above enables eliminating the torsions in the lateral direction of the group 40, maintains the grooving disc 41 (and/or the row cleaner disc 43) in the same angular position and serves as a damper with respect to the vertical thrust stresses due to the constraint reaction of the ground on the grooving disc 41 (and/or on the row cleaner disc 43).

The pre-load (i.e. the variation of the width of the concavity of the fourth arm 444 with respect to a stable balance position thereof) of the elasticity of the resilient articulated group 44, i.e. the fourth arm 444 thereof, is adjustable, for example by adjusting (as described above) the inclination of the second arm 442 with respect to the lower surface of the front longitudinal beam of the frame 11 by means of the peg 450.

Basically, the positioning of the peg 450 in a front seat (proximal to the hinge pin that hinges the second arm 442 to the coupling flange of the clamp element 45) defines an inclination of the second arm 442 with respect to the lower surface of the front longitudinal beam of the frame 11 by an angle, and thus a pre-load of the fourth arm 444, greater than the inclination defined by the positioning of the peg 450 in a rear seat (distal from the hinge pin that hinges the second arm 442 to the coupling flange of the clamp element 45) and, thus, of the pre-load of the fourth arm 444 with respect to such position.

The group 40 comprises at least one element 46 for limiting the rotation with respect to the oscillation axis (and/or height variation with respect to the articulation axis of the resilient articulated group 44) of the grooving disc 41 and/or of the row cleaner disc 43.

The limiting element 46 comprises a non-extensible flexible member, for example a chain of predefined length, which is fixed, for example by means of threaded members to the sowing group 30 rearwardly aligned with the group 40 and to the structure 42, for example by means of a bracket bolted to the non-extensible flexible member and fixed to the prongs 420 of the structure 42.

Thus, the limiting element 46 defines a lower end stop for the grooving disc 41 and/or for the row cleaner disc 43 (i.e. the structure 42).

Furthermore, the limiting element 46 simultaneously defines two juxtaposed rotational end stops for the grooving disc 41 and/or for the row cleaner disc 43 (i.e. the structure 42) with respect to the oscillation axis defined by the oscillation pin 422.

The invention thus conceived is susceptible to numerous modifications and variants all falling within the inventive concept.

In addition, all details can be replaced by other technically equivalent elements.

Basically, the materials used as well as the shapes and contingent dimensions, may vary according to the needs without departing from the scope of protection of the claims that follow.

1. A group for cleaning and making a furrow in a ground, comprising:
a frame suitable to be connected to a driving unit;
a rotary grooving disc provided with grooves;
wherein the grooving disc is articulated to the frame in a mobile fashion perpendicularly to the ground with respect to the frame by means of a resilient articulated group provided with mutually parallel articulation axes; and
wherein the resilient articulated group comprises at least one plurality of arms articulated with respect to mutually parallel horizontal articulation axes, among which there is at least one resiliently flexibly yieldable arm.

2. The group according to claim 1, wherein the resilient articulated group comprises a first arm connected to the grooving disc, a second arm fixed to the frame, a third arm hinged to the first arm and to the second arm and a fourth arm that is resiliently yieldable rigidly connected to the first arm and the second arm.

3. The group according to claim 1, wherein the grooving disc is pivotingly associated to the resilient articulated group about an oscillation axis perpendicular to the articulation axes of the resilient articulated group.

4. The group according to claim 3, comprising at least one element for limiting the rotation of the grooving disc about the oscillation axis.

5. The group according to claim 1, comprising at least an element for limiting the movement of the grooving disc with respect to the articulation axes of the resilient articulated group.

6. The group according to claim 1, comprising at least one rotary row cleaner disc arranged sideways to the grooving disc and having a revolution axis that is inclined with respect to the rotation axis of the grooving disc, the row cleaner disc being articulated to the frame of said resilient articulated group.

7. The group according to claim 6, wherein the at least one row cleaner disc is pivotingly associated to the resilient articulated group about said oscillation axis.

8. A sower comprising
a group for cleaning and making a furrow in the ground according to claim 1, and comprising a sowing group associated to the frame of the group for cleaning and making a furrow in the ground, wherein the sowing group is associated rearwardly to the group for cleaning and making a furrow in the ground with respect to an advancement direction thereof on the ground.

9. The sower according to claim 8, wherein the sowing group is articulated to the frame by means of a four-bar hinge having articulation axes parallel to the articulation axes of the resilient articulated group.

10. The sower according to claim 9, further comprising at least one element for limiting the rotation of the grooving disc about the oscillation axis wherein the limiting element comprises a non-extensible flexible member fixed to the sowing group and connected to the grooving disc.
